(19) United States
(12) Patent Application Publication
(10) Pub. No.: US 2011/0098913 A1
(43) Pub. Date: Apr. 28, 2011

(54) NAVIGATION DEVICE AND METHOD FOR DETERMINING A ROUTE OF TRAVEL

(76) Inventor: Victor Shcherbatyuk, Turnhout (BE)

(21) Appl. No.: 12/736,930

(22) PCT Filed: Dec. 23, 2008
(86) PCT No.: PCT/EP2008/068231

§ 371 Date: Jan. 6, 2011

(51) Int. Cl. G01C 21/36

(52) U.S. Cl. 701/200

(57) ABSTRACT

A method for route of travel determination in a navigation device is disclosed. In at least one embodiment, the method includes determining, using a processor of a portable navigation device, map information for a route of travel from a first location to a second location, based at least in part upon average speed data for at least one type of road along the route of travel. The method further includes displaying the determined map information on a display device of the navigation device. A navigation device is also disclosed. The navigation device includes a memory resource to store average speed data for a plurality of types of road and average speed data for a plurality of roads and a processor to determine map information for a route of travel from a first location to a second location, based at least in part upon the average speed data for at least one of the plurality of types of road along the route of travel. The navigation device further includes a display device to display the determined map information.

### FIELD

This disclosure relates to navigation devices and to methods for determining a route of travel from a first location to a second location. Illustrative embodiments relate to portable navigation devices (so-called PNDs); in particular PNDs that include Global Positioning System (GPS) signal reception and processing functionality. Other embodiments relate, more generally, to any type of processing device that is configured to execute navigation software so as to provide route planning, and preferably also navigation, functionality.

### BACKGROUND

Portable navigation devices (PNDs) that include GPS (Global Positioning System) signal reception and processing functionality are well known and are widely employed as in-car or other vehicle navigation systems.

Such devices are of great utility when the user is not familiar with the route to the destination to which they are navigating. However, determining a route of travel to a destination takes time. In order to calculate a “best” or “optimum” route, the average speed for each road segment along a possible route of travel is typically used. As the distance to the destination increases, the time to determine the route of travel generally increases. Users of a navigation device may become impatient waiting for the navigation device to determine the route of travel. Although using a faster processor in the navigation device may increase the speed at which the route of travel is calculated, faster processors are more expensive and tend to increase the cost of producing a navigation device.

### SUMMARY

According to one example embodiment, a method for route of travel determination in a navigation device is disclosed. The method includes determining, using a processor of a navigation device, map information for a route of travel from a first location to a second location, based at least in part upon average speed data for at least one type of road along the route of travel. The method further includes displaying the map information on a display device of the navigation device.

Another example embodiment of the present disclosure is directed to a navigation device. The navigation device includes a memory resource to store average speed data for a plurality of types of road and average speed data for a plurality of roads. The navigation device includes a processor to determine map information for a route of travel from a first location to a second location, based at least in part upon the average speed data for at least one of the plurality of types of road along the route of travel. The navigation device also includes a display device to display the determined map information.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present disclosure, and arrangements embodying those teachings, will hereafter be described by way of illustrative example with reference to the accompanying drawings, in which:

FIG. 1 is a schematic illustration of a Global Positioning System (GPS);

FIG. 2 is a schematic illustration of electronic components arranged to provide a navigation device;

FIG. 3 is a schematic illustration of the manner in which a navigation device may receive information over a wireless communication channel;

FIGS. 4A and 4B are illustrative perspective views of a navigation device;

FIGS. 5a to 5i are illustrative screenshots from a navigation device for a destination input process;

FIG. 6 is an illustrative screenshot from a navigation device depicting a start location for an illustrative calculated route; and

FIG. 7 is an illustrative flow diagram depicting steps of an example embodiment of a method of the present disclosure.

### DETAILED DESCRIPTION OF EXAMPLE EMBODIMENTS

Example embodiments of the present disclosure will now be described with particular reference to a PND. It should be remembered, however, that the teachings of the present disclosure are not limited to PNDs but are instead universally applicable to any type of processing device that is configured to execute navigation software so as to provide route planning and navigation functionality. It follows therefore that in the context of the present application, a navigation device is intended to include (without limitation) any type of route planning and navigation device, irrespective of whether that device is embodied as a PND, a navigation device built into a vehicle, or indeed a computing resource (such as a desktop or portable personal computer (PC), mobile telephone or portable digital assistant (PDA)) executing route planning and navigation software.

It will also be apparent from the following that the teachings of the present disclosure even have utility in circumstances where a user is not seeking instructions on how to navigate from one point to another, but merely wishes to be provided with a view of a given location. In such circumstances the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

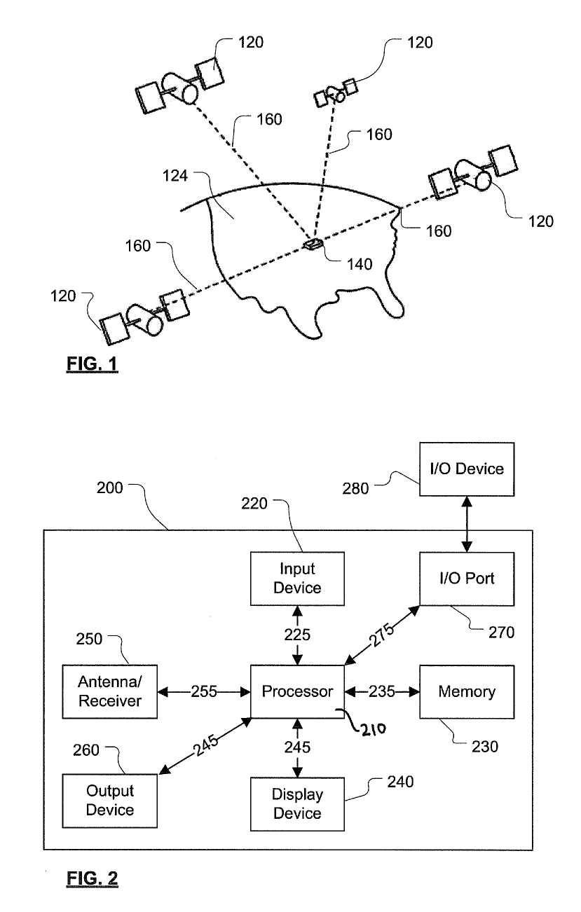

With the above provisos in mind, FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

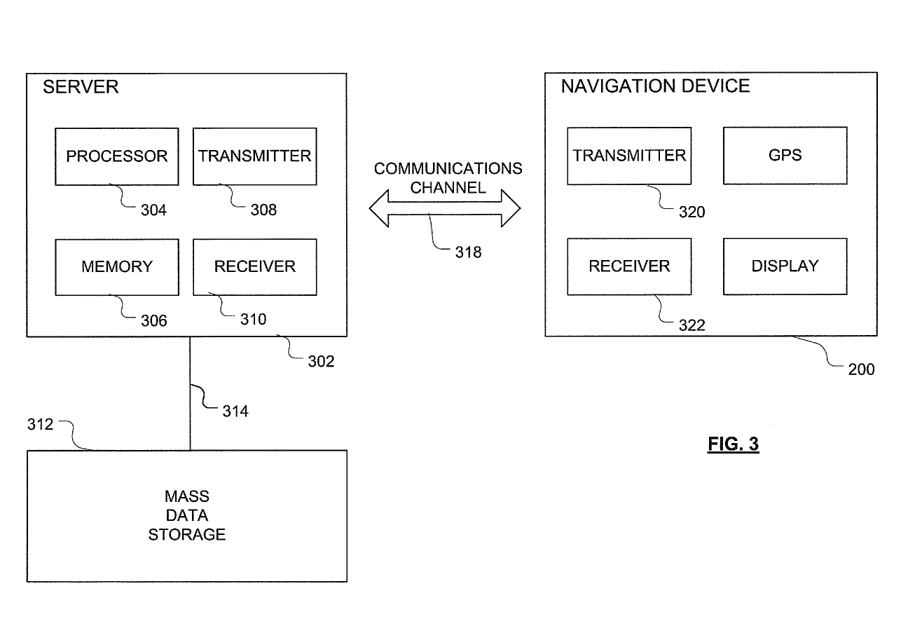

FIG. 2 is an illustrative representation of electronic components of a navigation device 200 according to an example embodiment of the present disclosure, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilised to input information; and the display screen 240 can include any type of display screen such as an LCD display, for example. In an example arrangement, the input device 220 and display screen 240 are integrated into an integrated input and display device, including a touchpad or touch screen input so that a user need only touch a portion of the display screen 240 to select one of a plurality of display choices or to activate one of a plurality of virtual buttons.

The navigation device may include an output device 260, for example an audible output device (e.g. a loudspeaker). As output device 260 can produce audible information for a user of the navigation device 200, it is should equally be understood that input device 240 can include a microphone and software for receiving input voice commands as well.

In the navigation device 200, processor 210 is operatively connected to and set to receive input information from input device 220 via a connection 225, and operatively connected to at least one of display screen 240 and output device 260, via output connections 245, to output information thereto. Further, the processor 210 is operably coupled to a memory resource 230 via connection 235 and is further adapted to receive/send information from/to input/output (I/O) ports 270 via connection 275, wherein the I/O port 270 is connectible to an I/O device 280 external to the navigation device 200. The memory resource 230 comprises, for example, a volatile memory, such as a Random Access Memory (RAM) and a non-volatile memory, for example a digital memory, such as a flash memory. The external I/O device 280 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use.

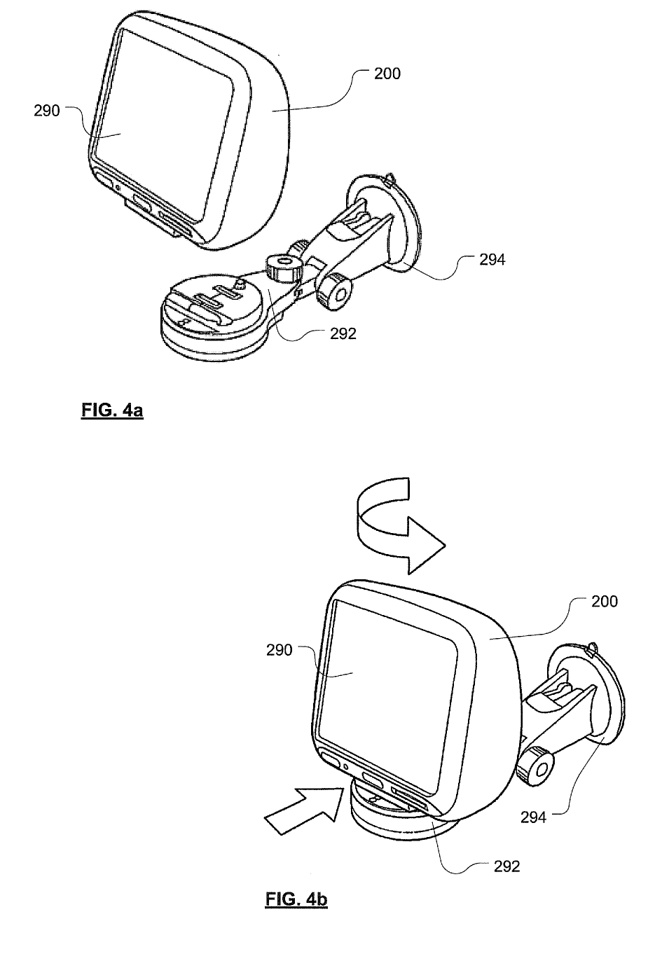

Referring now to FIG. 3, the navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet).

The navigation device 200 can further complete a data connection with the mobile device, and eventually with the internet and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet for example, in a manner similar to that of any mobile device.

For GRPS phone settings, a Bluetooth enabled navigation device may be used to correctly work with the ever changing spectrum of mobile phone models, manufacturers, etc., model/manufacturer specific settings may be stored on the navigation device 200 for example. The data stored for this information can be updated.

In FIG. 3 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated automatically or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 may be integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 260, such as audio input/output devices for example.

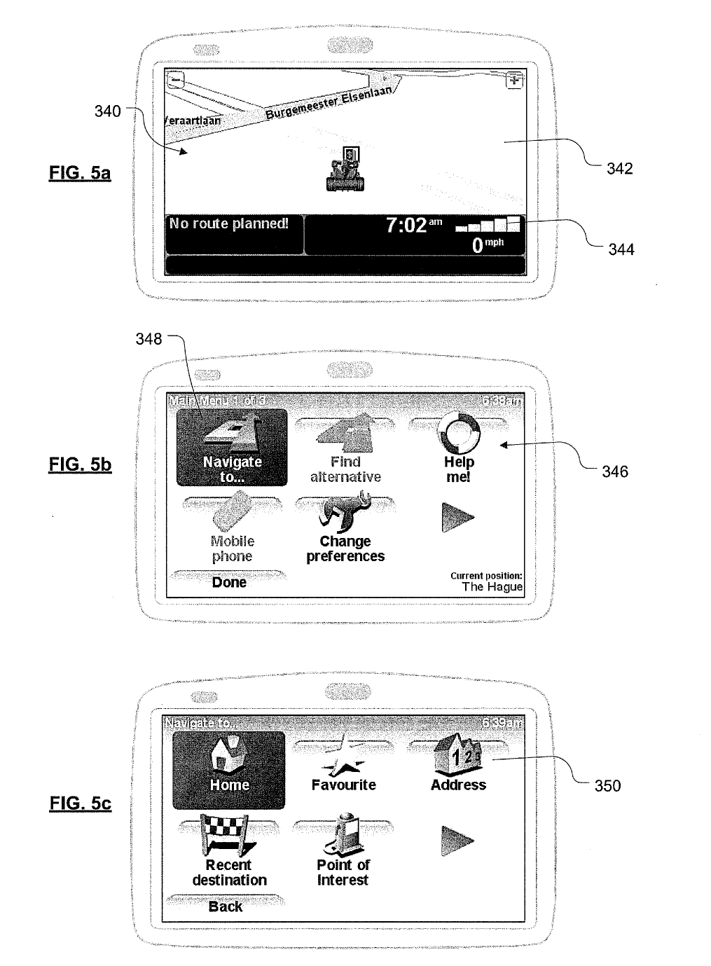

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 230, etc.).

The navigation device 200 may sit on an arm 292, which itself may be secured to a vehicle dashboard/window/etc. using a suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example. The navigation device 200 may then be rotatable on the arm 292, as shown by the arrow of FIG. 4B. To release the connection between the navigation device 200 and the docking station, a button on the navigation device 200 may be pressed, for example. Other equally suitable arrangements for coupling and decoupling the navigation device to a docking station are well known to persons of ordinary skill in the art.

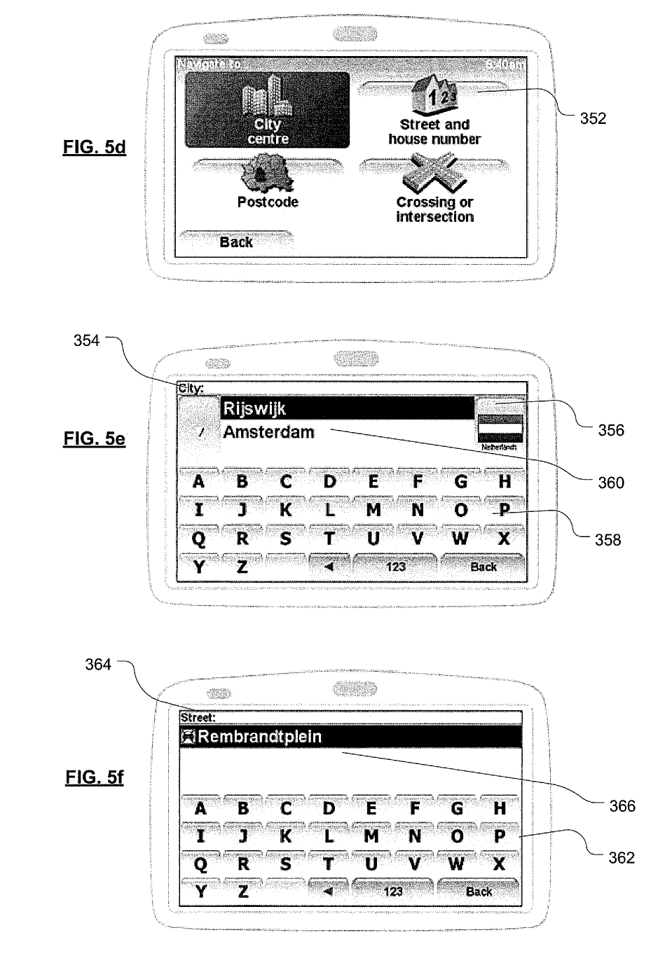

Referring now to FIGS. 5a to 5i there is depicted a series of screenshots from a navigation device 200. This navigation device 200 has a touch screen interface for displaying information to a user and for accepting input to the device from the user. The screenshots show an illustrative example embodiment of a destination location input process for a user whose home location has been set to the offices in The Hague of the European Patent Office, and who wishes to navigate to a street address in Amsterdam, The Netherlands for which they know the street name and building number.

When this user switches on their navigation device 200, the device acquires a GPS fix and calculates (in a known manner) the current location of the navigation device 200. The user is then presented, as shown in FIG. 5a, with a display 340 showing in pseudo three-dimensions the local environment 342 in which the navigation device 200 is determined to be located, and in a region 344 of the display 340 below the local environment a series of control and status messages.

By touching the display of the local environment 342, the navigation device 200 switches to display (as shown in FIG. 5b) a series of virtual buttons 346 by means of which a user can, inter alia, input a destination that they wish to navigate to.

By touching the “navigate to” virtual button 348, the navigation device 200 switches to display (as shown in FIG. 5c) a plurality of virtual buttons that are each associated with a different category of selectable destinations. In this instance, the display shows a “home” button that if pressed would set the destination to the stored home location. However, in this instance as the user is already at their home location (namely the EPO's offices in the Hague) selecting this option would not cause a route to be generated. The “favourite” button, if pressed, reveals a list of destinations that the user has previously stored in the navigation device 200 and if one of these destinations is then selected the destination for the route to be calculated is set to the selected previously stored destination. The “recent destination” button, if pressed, reveals a list of selectable destinations held in the memory of the navigation device 200 and to which the user has recently navigated. Selection of one of the destinations populating this list would set the destination location for this route to the selected (previously visited) location. The “point of interest” button, if pressed, reveals a number of options by which a user can opt to navigate to any of a plurality of locations, such as cash machines, petrol stations or tourist attractions for example, that have been pre-stored in the device as locations that a user of the device might want to navigate to. The “arrow” shaped virtual button opens a new menu of additional options, and the “address” button 350 commences a process by which the user can input the street address of the destination that they wish to navigate to.

Since the user, in this example, knows the street address of the destination that they wish to navigate to, it is assumed that this “address” button is operated (by touching the button displayed on the touch screen), whereupon (as shown in FIG. 5d) the user is presented with a series of address input options—in particular for address input by “city centre”, by “postcode”, by “crossing or intersection” (for example a junction of two roads) and by “street and house number”.

In this example the user knows the street address and house number of the destination and hence selects the “street and house number” virtual button 352 whereupon the user is then presented, as shown in FIG. 5e, a prompt 354 to enter the name of the city that they wish to navigate to, a flag button 356 by which the user can select the country in which the desired city is located, and a virtual keyboard 358 that may be operated by the user, if necessary, to input the name of the destination city. In this instance the user has previously navigated to locations in Rijswijk and Amsterdam, and the PND therefore additionally provides the user with a list 360 of selectable cites.

The user in this instance wishes to navigate to Amsterdam, and on selection of Amsterdam from the list 360 the navigation device 200 displays, as shown in FIG. 5f, a virtual keyboard 362 by means of which a user can input street names, a prompt 364 for entry of a street name 364 and, in this instance, as the user has previously navigated to a street in Amsterdam, a list 366 of selectable streets in Amsterdam.

In this example the user wishes to return to the street, Rembrandtplein, that they have previously visited and so selects Rembrandtplein from the displayed list 366. Once a street has been selected, the navigation device 200 then displays a smaller virtual keypad 368 and prompts the user, via prompt 370, to enter the number of the house in the selected street and city that they wish to navigate to. If the user has previously navigated to a house number in this street, then that number (as shown in FIG. 5g) is initially shown. If, as in this instance, the user wishes to navigate to No. 35, Rembrandtplein once again, then the user need only touch a “done” virtual button 372 displayed at the bottom right hand corner of the display. If the user should wish to navigate to a different house number in Rembrandtplein, then all they need do is operate the keypad 368 to input the appropriate house number.

Once the house number has been input, the user is asked in FIG. 5h, whether they wish to arrive at a particular time. If the user should push the “yes” button, then functionality is invoked that estimates the time required to travel to the destination and advises the user when they should leave (or if they are running late, should have left) their current location in order to arrive at their destination on time. In this instance the user is not concerned about arriving at a particular time and hence selects the “no” virtual button.

Selecting the “no” button 374 causes the navigation device 200 to calculate a route between the current location and the selected destination and to display that route 376, as shown in FIG. 5i, on a relatively low magnification map that shows the entire route. The user provided with a “done” virtual button 378 which they can press to indicate that they are happy with the calculated route, a “find alternative” button 380 that the user can press to cause the navigation device 200 to calculate another route to the selected destination, and a “details” button 382 that a user can press to reveal selectable options for the display of more detailed information concerning the currently displayed route 376.

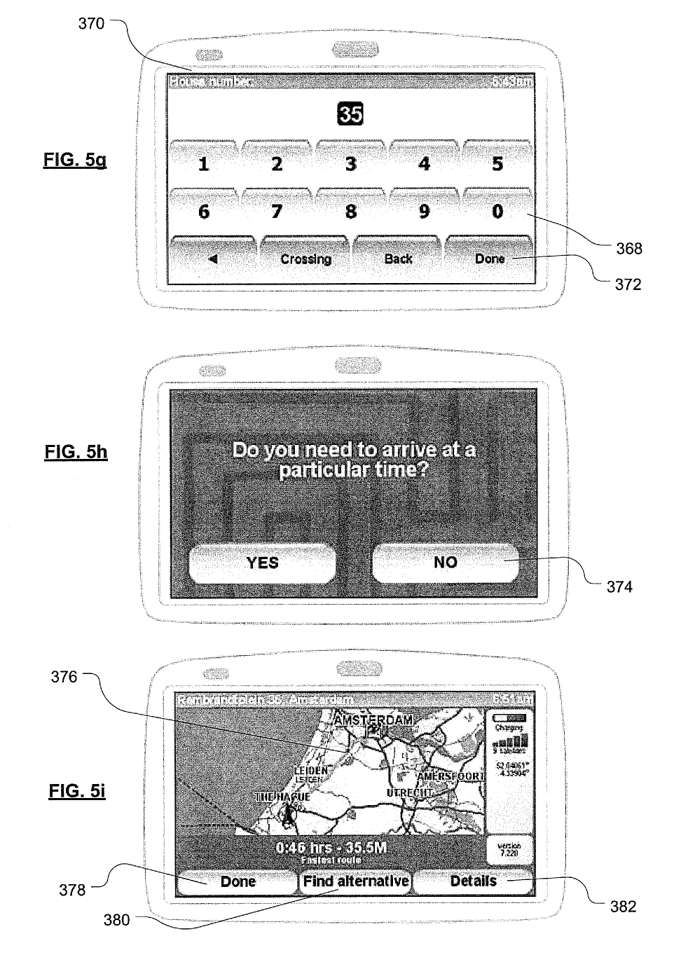

In this instance it is assumed that the user is happy with the displayed route, and once the “done” button 378 has been pressed the user is presented, as shown in FIG. 6, with a pseudo three-dimensional view of the current, start, location for the navigation device 200. The display depicted in FIG. 6 is similar to that shown in FIG. 5a except that the displayed local environment 342 now includes a start location flag 384 and a waypoint indicator 386 indicating the next manoeuvre (in this instance, a left hand turn). The lower part of the display has also changed and now displays the name of the street in which the navigation device 200 is currently located, an icon 388 indicating the distance to and type of the next manoeuvre (from the current location of the navigation device 200), and a dynamic display 390 of the distance and time to the selected destination.

The user then commences their journey and the navigation device 200 guides the user, in a known manner, by updating the map in accordance with determined changes in navigation device 200 location, and by providing the user with visual and, optionally, audible navigation instructions.

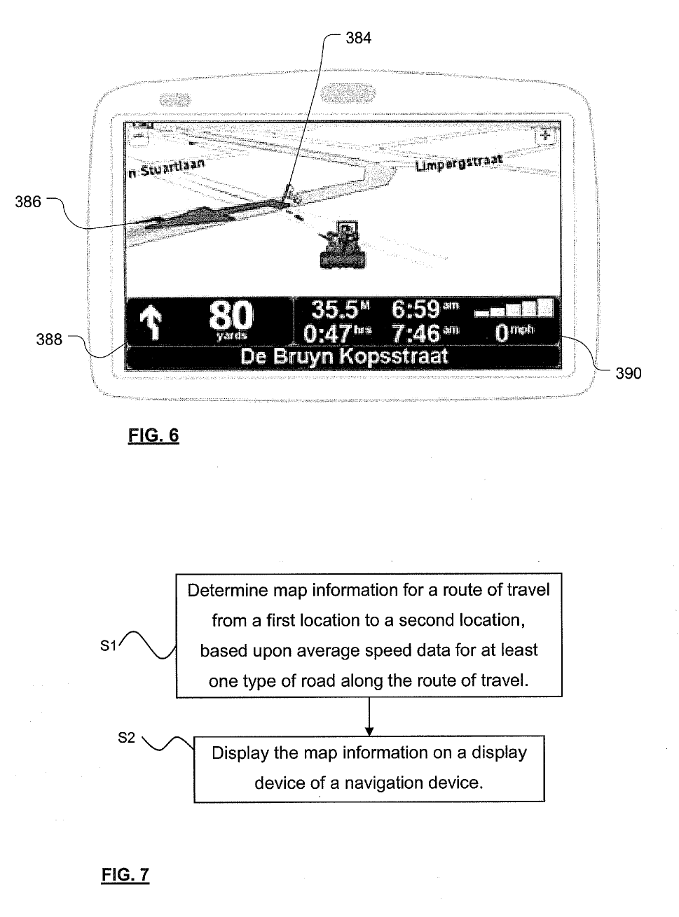

According to various embodiments of the present application, and as illustrated in FIG. 7, a method for route of travel determination in a portable navigation device 200 is disclosed. The method includes, at S1, determining, using a processor 210 of a portable navigation device 200, map information for a route of travel from a first location to a second location. The determination is based at least in part upon average speed data for at least one type of road along the route of travel. At S2, the method further includes displaying the determined map information on a display device 240 of the navigation device 200.

It should be noted that aspects of an embodiment of the present application have been, and will be, described with regard to the method of the present application. However, at least one embodiment of the present application is directed to a navigation device 200 including a memory resource 230 containing average speed data for a plurality of types of road and average speed data for a plurality of roads, a processor 210 to determine map information for a route of travel from a first location to a second location, based at least in part upon average speed data for at least one of the plurality of types of road along the route of travel and a display device 220 for displaying the map information, wherein the display device 220 may be part of an integrated input and display device 290. Thus, such a navigation device 200 may be used to perform various aspects of the method described above, as would be understood by one of ordinary skill in the art. Further explanation is, thus, omitted for the sake of brevity.

After a user of the navigation device 200 inputs a desired destination as discussed above, the processor 210 begins to determine a route of travel from a first location, generally the user's present location, to a second location, i.e. the desired destination. The processor 210 uses stored average speed data for each type of road (stored in memory resource 230 for example) along the possible routes of travel to determine the route of travel. Example types of road may include, but are not limited to, local paved roads, dirt roads, brick roads, highways, two lane streets, four lane streets, turnpikes, etc.

Each of the various types of road is associated with average speed data. Thus, for example, highways may be associated with an average speed of 88 KPH, while two lane streets may be associated with an average speed of 50 KPH. In an embodiment of the present application, this average speed data is an average of many streets of the road type, and not an average speed of any particular road along the route of travel. This allows the route of travel to be determined more quickly and/or efficiently than if the average speeds of the actual roads along the route of travel are used.

The processor 210 only needs to retrieve the average speed data for each type of road along the route of travel. Hence, if a possible route of travel includes three different highway segments and three two lane street segments, the processor 210 need only retrieve two average speeds from the memory resource 230, i.e. the highway average speed and the two lane street average speed, rather than six separate average speeds, one for each road segment.

After the route of travel is determined in such a manner, map information relating to the determined route of travel is then displayed to the user on the display device 220 and the user may begin travelling to the destination as discussed above.

After the route of travel has been determined in the manner discussed above, the processor 210 may also determine whether a revised route of travel would result in a relatively shorter travel time from the first location to the second location. This revised route of travel is calculated, in one embodiment of the present application, using stored average speed data for the actual roads, or segments, along the revised route of travel. Although an average speed of 88 KPH may have been used for all highway segments along the route of travel, the average speed for the particular highway segments along the route of travel may actually be, for example, 50 KPH, 35 KPH and 80 KPH. Therefore, some other road segments that may be used may have faster average speeds than the actual average speed of the highway segments of the determined route of travel.

As discussed above, such a calculation using average speed data of the specific road segments will generally take longer than a calculation of the route of travel in the manner above. However, because the route of travel was initially determined in the manner above, the user may begin travelling to the destination while the revised route of travel is determined by the processor 210 in the background, i.e. the user does not necessarily see or know that the calculation is being performed. If a relatively shorter travel time is then determined for a revised route of travel using the average speed data for the roads, or segments, along the revised route of travel, the processor 210 can determine the revised route of travel, and can control display of revised map information on the display 220 (in place of the previously displayed determined map information, for example), thereby altering the route of travel to the revised route of travel.

Alternative embodiments of the invention can be implemented as a computer program product for use with a computer system, the computer program product being, for example, a series of computer instructions or program segments stored on a tangible data recording medium (computer readable medium), such as a diskette, CD-ROM, ROM, or fixed disk, or embodied in a computer data signal, the signal being transmitted over a tangible medium or a wireless medium, for example, microwave or infrared. The series of computer instructions or program segments can constitute all or part of the functionality of the method of embodiments described above, and can also be stored in any memory device, volatile or non-volatile, such as semiconductor, magnetic, optical or other memory device.

It will also be appreciated that whilst various aspects and embodiments of the present disclosure have heretofore been described, the scope of the present disclosure is not limited to the particular arrangements set out herein and instead extends to encompass all arrangements, and modifications and alterations thereto, which fall within the scope of the appended claims.

For example, whilst embodiments described in the foregoing detailed description refer to GPS, it should be noted that the navigation device 200 may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

It will also be well understood by persons of ordinary skill in the art that whilst the example embodiment implements certain functionality by means of software, that functionality could equally be implemented solely in hardware (for example by way of one or more ASICs (application specific integrated circuit)) or indeed by a mix of hardware and software. As such, the scope of the present disclosure should not be interpreted as being limited only to being implemented in software.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method for route of travel determination in a navigation device, the method comprising:
determining, using a processor of a navigation device, map information for a route of travel from a first location to a second location, based at least in part upon average speed data for at least one type of road along the route of travel; and
displaying the determined map information on a display device of the navigation device.

2. The method of claim 1 further comprising determining, using the processor, whether a revised route of travel from the first location to the second location will result in a relatively shorter travel time from the first location to the second location based at least in part upon average speed data for at least one road along the revised route of travel.

3. The method of claim 1, further comprising determining, using the processor, revised map information for a revised route of travel based at least in part upon average speed data for at least one road along the revised route of travel.

4. The method of claim 3 further comprising displaying the revised map information in place of the determined map information on the display device when the revised route of travel will result in a relatively shorter travel time from the first location to the second location.

5. A non-transitory computer readable medium including program segments for, when executed on a processor of a navigation device, causing the navigation device to implement the method of claim 1.

6. A navigation device, comprising:
a memory resource to store average speed data for a plurality of types of roads and average speed data for a plurality of roads;
a processor to determine map information for a route of travel from a first location to a second location, based at least in part upon the average speed data for at least one of the plurality of types of road along the route of travel; and
a display device to display the determined map information.

7. The navigation device of claim 6, wherein the processor is further configured to determine whether a revised route of travel from the first location to the second location will result in a relatively shorter travel time from the first location to the second location based at least in part upon average speed data for at least one road along the revised route of travel.

8. The navigation device of claim 6, wherein the processor is further configured to determine revised map information for a revised route of travel from a first location to a second location, based at least in part upon average speed data for at least one road along the revised route of travel.

9. The navigation device of claim 8, wherein the processor is further configured to control display of the revised map information in place of the determined map information on the display device when the revised route of travel will result in a relatively shorter travel time from the first location to the second location.

10. The navigation device of claim 6, wherein the display device is part of an integrated input and display device.

11. The navigation device of claim 6, wherein the navigation device is a portable navigation device (200).

12. The navigation device of claim 6, wherein the navigation device is integrated into a vehicle.

13. A navigation device, comprising:
means for storing average speed data for a plurality of types of roads and average speed data for a plurality of roads;
means for determining map information for a route of travel from a first location to a second location, based at least in part upon the average speed data for at least one of the plurality of types of road along the route of travel; and
means for displaying the determined map information.

14. The navigation device of claim 13, wherein the means for determining is further for determining whether a revised route of travel from the first location to the second location will result in a relatively shorter travel time from the first location to the second location based at least in part upon average speed data for at least one road along the revised route of travel.

15. The navigation device of claim 13, wherein the means for determining is further for determining revised map information for a revised route of travel from a first location to a second location, based at least in part upon average speed data for at least one road along the revised route of travel.

16. The navigation device of claim 15, wherein the means for determining is further for controlling display of the revised map information in place of the determined map information on the means for displaying when the revised route of travel will result in a relatively shorter travel time from the first location to the second location.

17. The navigation device of claim 13, wherein the means for displaying is part of an integrated input and display device.

18. The navigation device of claim 13, wherein the navigation device is a portable navigation device.

19. The navigation device of claim 13, wherein the navigation device is integrated into a vehicle.
